(19) United States
(12) Patent Application Publication
(10) Pub. No.: US 2010/0079249 A1
(43) Pub. Date: Apr. 1, 2010

(54) COMMUNICATION DEVICE AND METHOD FOR ACQUIRING INFORMATION OF RADIO FREQUENCY IDENTIFICATION TAGS

(75) Inventor: TSE-CHUNG PAN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City, Taipei County (TW)

(21) Appl. No.: 12/501,567

(22) Filed: Jul. 13, 2009

(30) Foreign Application Priority Data
Sep. 26, 2008 (CN) 200810304692.3

(51) Int. Cl. H04Q 5/22

(52) U.S. Cl. 340/10.1

(57) ABSTRACT

A communication device and method for acquiring information of radio frequency identification (RFID) tags include setting a RFID tag search request comprising header information of the predetermined RFID tags, and searching a RFID tag according to the RFID tag search request. The communication device and method further include acquiring position information of a location of the communication device if a found RFID tag is a predetermined RFID tag, and sending the position information and header information of the found RFID tag to a server that collects information of the predetermined RFID tags.

### BACKGROUND

1. Technical Field

Embodiments of the present disclosure relate to information management, and more particularly to a communication and method for acquiring information of radio frequency identification (RFID) tags.

2. Description of Related Art

An object (e.g., cargo, luggage) may include a RFID tag that records information of the object. For example, a RFID tag in a luggage may record a serial number of the luggage, a name of an owner of the luggage, and a phone number of the owner. The information recorded in the RFID tag may be read by a RFID reader. By utilizing the RFID reader and the RFID tag, information may be read and collected automatically and rapidly. However, if RFID tags are embedded in distributed or moving objects, it is difficult to retrieve information of the RFID tags.

What is needed, therefore, is an improved communication device and method for acquiring information of RFID tags.

### BRIEF DESCRIPTION OF THE DRAWINGS

FIG. 1 is a block diagram of one embodiment of a communication device in communication with a server through a plurality of base stations.

FIG. 2 is a block diagram of one embodiment of the communication device including an acquiring system.

FIG. 3 is a flowchart of one embodiment of a method for acquiring information of RFID tags.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

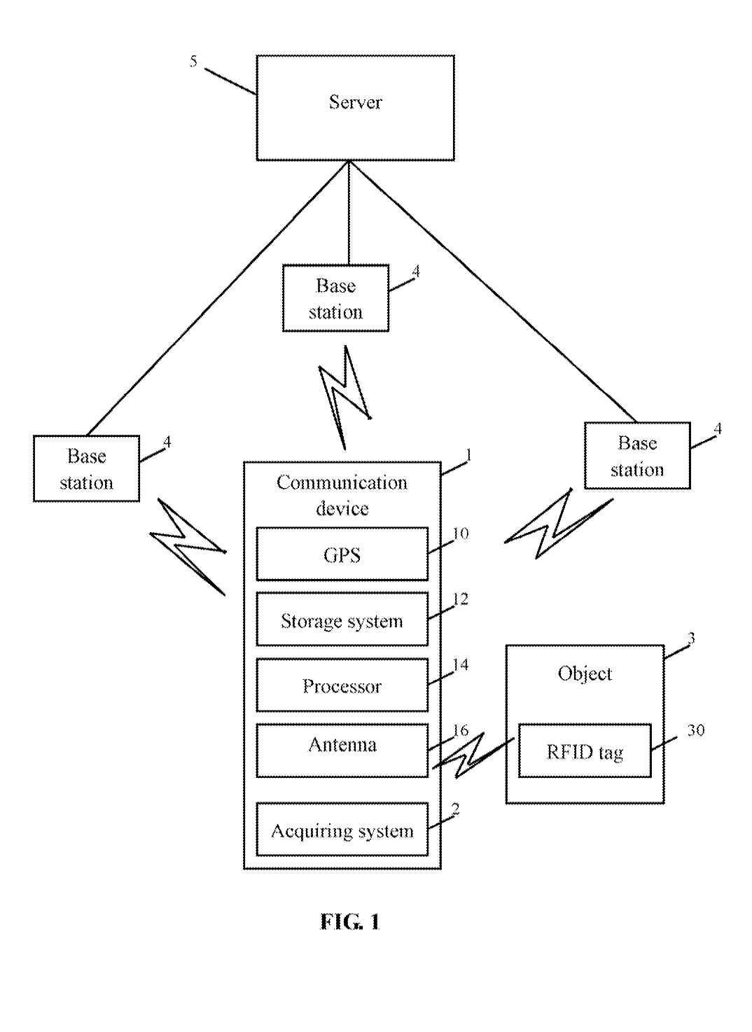

FIG. 1 is a block diagram of one embodiment of a communication device 1 in communication with a server 5 through a plurality of base stations 4. In the embodiment of FIG. 1, the communication device 1 may include a global position system (GPS) 10 and an acquiring system 2. The GPS 10 may be used to locate the communication device 1. The acquiring system 2 may be used to acquire information of a radio frequency identification (RFID) tag 30 embedded in an object 3, and to acquire position information of the communication device 1 from the GPS 10. The acquiring system 2 may be further used to send the acquired information of the RFID tag 30 and the position information of the communication device 1 to the server 5.

In one embodiment, the server 5 may be used to collect information of predetermined RFID tags embedded in or attached to specified objects. The server 5 may be a host computer, for example. In one embodiment, the server 1 may be a web server, which provides a website including various webpages for people to register, browse, or upload information, for example.

RFID tags may be included in various objects. For example, a pet dog may wear a dog collar that is embedded with a RFID tag. The RFID tag may record information of the pet dog, such as a name of the pet dog, an address and a contact phone number of an owner of the pet dog, for example. The header information of the RFID tag may be the name of the pet dog. The owner may preset the header information (e.g., the name of the pet dog) of the RFID tag in the server 5 if the pet dog is lost. If the pet dog is lost, a communication device may set RFID tag search requests including the header information of the RFID tag. If a communication device acquires the header information (e.g., the name of the pet dog), the communication device may send the header information and current position information of the communication device to the server 5. The owner may query the server 5 and acquire the position information of the communication device. In another example, various additional objects may include RFID tags to be tracked or monitored, such as luggage, grocery items, and personal items.

The communication device 1 may be a mobile phone, a personal digital assistant, a handheld computer, or any other kind of computing device. The communication device 1 may further include a storage system 12, a processor 14, and an antenna 16. The antenna 16 may be used to send radio frequency (RF) signals to search RFID tags proximate to the communication device 1. The storage system 12 stores one or more programs, such as programs of an operating system, other applications of the communication device 1, and various kinds of data, such as header information of predetermined RFID tags, for example. In one embodiment, the communication device 1 may be a mobile phone, and the storage system 12 may be a memory of the communication device 1 or an external storage card, such as a memory stick, a subscriber identification module (SIM) card, a smart media card, a compact flash card, or any other type of memory card. The processor 14 executes one or more computerized operations of the communication device 1 and other applications, to provide functions of the communication device 1.

In the embodiment of FIG. 1, the communication device 1 may communicate with the server 5 through a plurality of base stations 4. The base stations 4 may be wireless base stations or mobile telephone base stations, for example. A user of the communication device 1 may access the server 5 to transmit information through the plurality of base stations 4.

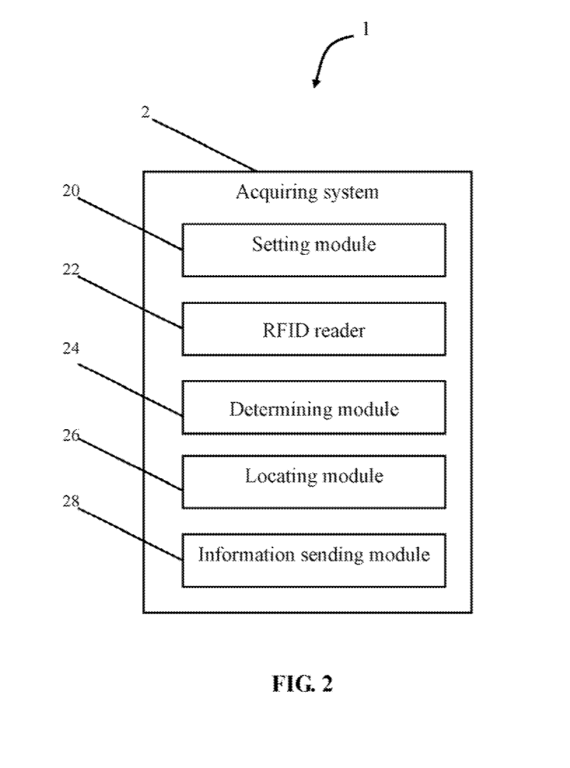

FIG. 2 is a block diagram of one embodiment of the communication device 1 including the acquiring system 2. In one embodiment, the acquiring system 2 includes a setting module 20, a RFID reader 22, a determining module 24, a locating module 26, and an information sending module 28. The modules 20, 24, 26, and 28 may comprise one or more computerized operations to be executed by the processor 14 to perform one or more operations of the communication device 1.

In one embodiment, information (e.g., header information) of specified RFID tags in the server 5 may be preset. In one example, the information may be preset by a user. In one embodiment, the specified RFID tags may be embedded in or be attached to specified objects (e.g., luggage, bracelets, necklaces). In another embodiment, the specified objects may be carried or surgically implanted in people or animals (e.g., criminals, dogs) to locate the people or the animals. Hereinafter, the specified RFID tags are referred to as “the predetermined RFID tags.”

The setting module 20 sets a RFID tag search request, which includes header information of the predetermined RFID tags. The setting module 20 further stores the RFID tag search request in the storage system 12 of the communication device 1.

The RFID reader 22 sends RF signals through the antenna 16 to search a RFID tag according to the RFID tag search request. The RFID reader 22 also determines if any RFID tag is found proximate to a location of the communication device 1. If a RFID tag is found, the RFID reader 22 reads header information of the found RFID tag.

The determining module 24 determines if the found RFID tag is a predetermined RFID tag by comparing the header information of the found RFID tag with the header information of the predetermined RFID tags. If the header information of the found RFID tag matches the header information of the predetermined RFID tags, the determining module determines that the found RFID tag is the predetermined RFID tag. Otherwise, if the header information of the found RFID tag does not match any header information of the predetermined RFID tags, the determining module determines that the found RFID tag is not the predetermined RFID tag.

If the found RFID tag is the predetermined RFID tag, the locating module 26 acquires position information of the location of the communication device 1 using the GPS 10. The locating module 26 may acquire the position information of the communication device 1 according to locations of at least three base stations 4 that communicates with the communication device 1. The position information of the location may include longitude, latitude, altitude, and/or a name of each location.

The information sending module 28 sends the position information of the communication device 1 and the header information of the found RFID tag to the server 5. In one embodiment, the position information of the communication device 1 and the header information of the found RFID tag may be sent to the server 5 by messages or E-mails.

The server 5 receives and stores the position information of the communication device 1 and the header information of the found RFID tag. The server 5 may provide the information stored therein to locate lost objects, animals, people, for example.

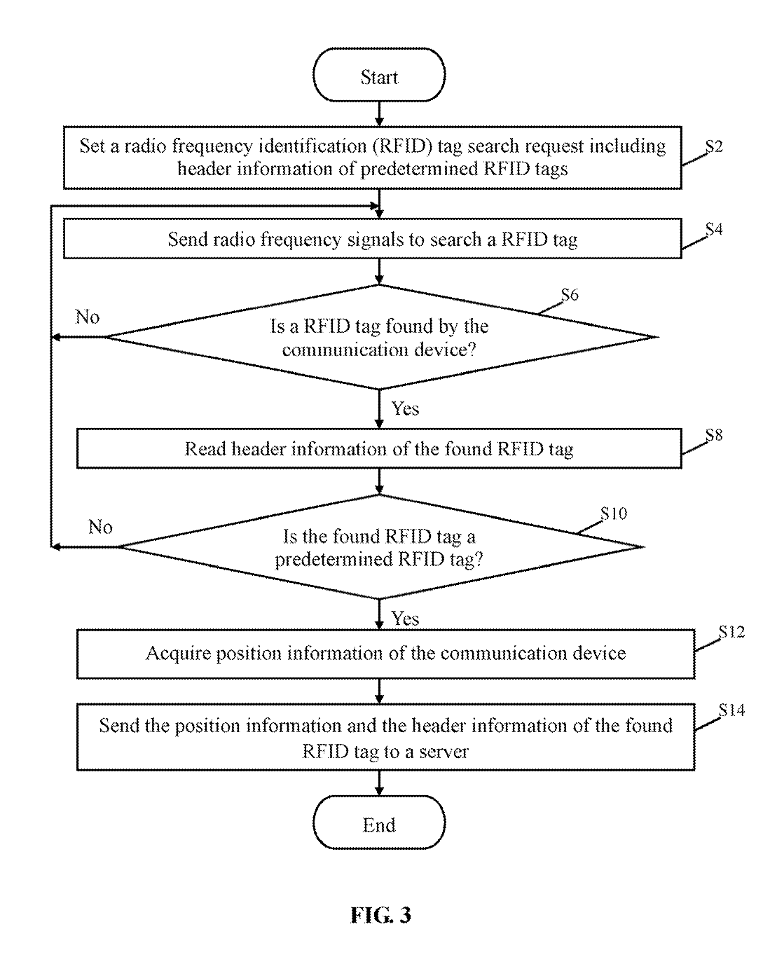

FIG. 3 is a flowchart of one embodiment of a method for acquiring information of RFID tags by the communication device 1. Depending on the embodiment, additional blocks may be added, others removed, and the ordering of the blocks may be replaced.

In block S2, the setting module 20 sets a RFID tag search request, which includes header information of the predetermined RFID tags. The setting module 20 further stores the RFID tag search request in the storage system 12 of the communication device 1.

In block S4, the RFID reader 22 sends RF signals through the antenna 16 to search a RFID tag according to the RFID tag search request.

In block S6, the RFID reader 22 determines if any RFID tag is found proximate to the location of the communication device 1. If a RFID tag is found, in block S8, the RFID reader 22 reads header information of the found RFID tag. If no RFID tag is found, the procedure returns to block S4.

In block S10, the determining module 24 determines if the found RFID tag is a predetermined RFID tag by comparing the header information of the found RFID tag with the header information of the predetermined RFID tags. If the header information of the found RFID tag matches the header information of the predetermined RFID tags, the determining module determines that the found RFID tag is the predetermined RFID tag. Otherwise, if the header information of the found RFID tag does not match any header information of the predetermined RFID tags, the determining module determines that the found RFID tag is not the predetermined RFID tag.

If the found RFID tag is not the predetermined RFID tag, the procedure returns to block S4. If the found RFID tag is the predetermined RFID tag, in block S12, the locating module 26 acquires position information of a location of the communication device 1 using the GPS 10. In another embodiment, the locating module 26 may acquire the position information of the communication device 1 according to locations of at least three base stations 4 that communicates with the communication device 1. As mentioned above, the position information of the location may include longitude, latitude, altitude, and/or a name of each location.

In block S14, the information sending module 28 sends the position information of the communication device 1 and the header information of the found RFID tag to the server 5. As mentioned above, the server 5 receives and stores the position information of the communication device 1 and the header information of the found RFID tag. The server 5 may provide the information stored therein to locate lost objects, animals, people, for example.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for acquiring information of radio frequency identification (RFID) tags by a communication device, the communication device in communication with a server that collects information of predetermined RFID tags through a plurality of base stations, the method comprising:
setting a RFID tag search request comprising header information of the predetermined RFID tags
sending radio frequency signals by a RFID reader of the communication device to search a RFID tag according to the RFID tag search request;
reading header information of a found RFID tag by the RFID reader;
determining if the found RFID tag is a predetermined RFID tag by comparing the header information of the found RFID tag with the header information of the predetermined RFID tags;
acquiring position information of the location of the communication device if the found RFID tag is a predetermined RFID tag; and
sending the position information of the communication device and the header information of the found RFID tag to the server.

2. The method according to claim 1, wherein the determining step comprises:
determining that the found RFID tag is the predetermined RFID tag if the header information of the found RFID tag matches the header information of the predetermined RFID tags; or
determining that the found RFID tag is not the predetermined RFID tag if the header information of the found RFID tag does not match any header information of the predetermined RFID tags.

3. The method according to claim 1, wherein the position information of the communication device is acquired by using a global position system (GPS) of the communication device.

4. The method according to claim 1, wherein the position information comprises longitude, latitude, and altitude of the location.

5. The method according to claim 1, wherein the position information of the communication device and the header information of the found RFID tag are sent to the server by messages or E-mails.

6. The method according to claim 1, wherein each of the predetermined RFID tags is embedded in or attached to an object to be tracked.

7. A communication device, the communication device in communication with a server that collects information of predetermined radio frequency identification (RFID) tags through a plurality of base stations, the communication device comprising:
a storage system;
at least one processor; and
one or more programs stored in the storage system and being executable by the at least one processor, the one or more programs comprising:
a setting module operable to set a RFID tag search request comprising header information of the predetermined RFID tags;
a RFID reader operable to send radio frequency signals through an antenna of the communication device to search a RFID tag according to the RFID tag search request, and read header information of a found RFID tag;
a determining module operable to determine if the found RFID tag is a predetermined RFID tag by comparing the header information of the found RFID tag with the header information of the predetermined RFID tags;
a locating module operable to acquire position information of the location of the communication device if the found RFID tag is a predetermined RFID tag; and
an information sending module operable to send the position information of the communication device and the header information of the found RFID tag to the server.

8. The communication device according to claim 7, wherein the determining module is further operable to determine that the found RFID tag is the predetermined RFID tag if the header information of the found RFID tag matches the header information of the predetermined RFID tags, or determine that the found RFID tag is not the predetermined RFID tag if the header information of the found RFID tag does not match any header information of the predetermined RFID tags.

9. The communication device according to claim 7, wherein the locating module acquires the position information of the communication device by using a global position system (GPS) of the communication device.

10. The communication device according to claim 7, wherein the position information comprises longitude, latitude, and altitude of the location.

11. The communication device according to claim 7, wherein the information sending module sends the position information of the communication device and the header information of the found RFID tag to the server by messages or E-mails.

12. The communication device according to claim 7, wherein each of the predetermined RFID tags is embedded in or attached to an object to be tracked.

13. A storage medium storing a set of instructions, the set of instructions capable of being executed by a processor to perform a method for acquiring information of radio frequency identification (RFID) tags by a communication device, the communication device in communication with a server that collects information of predetermined RFID tags through a plurality of base stations, the method comprising:
setting a RFID tag search request comprising header information of the predetermined RFID tags
sending radio frequency signals by a RFID reader of the communication device to search a RFID tag according to the RFID tag search request;
reading header information of a found RFID tag by the RFID reader;
determining if the found RFID tag is a predetermined RFID tag by comparing the header information of the found RFID tag with the header information of the predetermined RFID tags;
acquiring position information of the location of the communication device if the found RFID tag is a predetermined RFID tag; and
sending the position information of the communication device and the header information of the found RFID tag to the server.

14. The storage medium as claimed in claim 13, wherein the determining step comprises:
determining that the found RFID tag is the predetermined RFID tag if the header information of the found RFID tag matches the header information of the predetermined RFID tags; or
determining that the found RFID tag is not the predetermined RFID tag if the header information of the found RFID tag does not match any header information of the predetermined RFID tags.

15. The storage medium as claimed in claim 13, wherein the position information of the communication device is acquired by using a global position system (GPS) of the communication device.

16. The storage medium as claimed in claim 13, wherein the position information comprises longitude, latitude, and altitude of the location.

17. The storage medium as claimed in claim 13, wherein the position information of the communication device and the header information of the found RFID tag are sent to the server by messages or E-mails.

18. The storage medium as claimed in claim 13, wherein each of the predetermined RFID tags is embedded in or attached to an object to be tracked.
